(19) United States
(12) Patent Application Publication
(10) Pub. No.: US 2016/0336549 A1
(43) Pub. Date: Nov. 17, 2016

(54) RIGID BATTERY MODULE FRAME OF POLYMERIC MATERIAL

(71) Applicant: GM Global Technology Operations LLC, Detroit, MI (US)

(72) Inventors: Roger M. Brisbane, Washington, MI (US); Nicholas W. Compton, Freeland, MI (US); Michael G. Menrath, Sterling Heights, MI (US)

(21) Appl. No.: 14/708,365

(22) Filed: May 11, 2015

(51) Int. Cl. H01M 2/02; H01M 10/625; H01M 10/04; H01M 10/6551; H01M 2/12; H01M 2/30; H01M 10/613; H01M 10/647

(52) U.S. Cl. CPC H01M 2/0262; H01M 10/613; H01M 10/625; H01M 10/647; H01M 10/6551; H01M 2/12; H01M 2/30; H01M 10/0413; H01M 2220/20

(57) ABSTRACT

A modular battery pack assembly and method of making the same. Prismatic battery cells are placed along a stacking axis within a structural frame that is made of a polymeric material that includes foldable components made up of a top section disposed adjacent an edge of the stacked cells, and numerous side sections cooperatively coupled to the top sections to define an enclosure about the cells. In one form, apertures, protrusions and other features may be formed in or on the enclosure surface that faces or otherwise engages the cells, while in another form, built-in hinges permit selective latching between adjacent enclosure sections. A bottom section, which may be made of the same or similar material, may be secured to the remainder of the enclosure that is formed by the top and side sections such that the stacked cells are completely enclosed in a portable, modular assembly. In assembling the battery pack, top-down construction is employed so that the edge of the cell stack that defines the battery electrical terminals is first seated into the top section of the frame along a generally downward vertical axis.

### BACKGROUND OF THE INVENTION

This invention relates generally to packaging structure for battery cells within a battery pack, and more particularly to coupling a low part-count rigid frame made of a polymeric material for containing and supporting the battery cells.

Lithium-ion and related batteries, collectively known as a rechargeable energy storage system (RESS), are being used in automotive and related transportation applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes such batteries ideal to serve as part of a propulsion system for cars, trucks, buses, motorcycles and related vehicular platforms. In one form suitable for automotive applications, individual battery cells (i.e., a single electrochemical unit) are shaped as generally thin rectangular members. The flow of electric current to and from the cells is such that when several such cells are combined into larger assemblies, the current or voltage can be increased to generate the desired power output. In the present context, larger module and pack assemblies are made up of one or more cells joined in series, parallel or both, and may include additional structure to ensure proper installation and operation of these calls. Although the term “battery pack” is used herein to discuss a substantially complete battery assembly for use in propulsive power applications, it will be understood by those skilled in the art that related terms—such as “battery unit” or the like—may also be used to describe such an assembly and that either term may be used interchangeably without a loss in such understanding.

In one form, the individual cells that make up a battery pack are configured as rectangular (i.e., prismatic) cans that define a rigid outer housing known as a cell case. As with their similarly-shaped prismatic pouch cell counterparts, prismatic can-style cells can be placed in a facing arrangement (much like a deck of cards) along a stacking axis formed by the aligned parallel plate-like surfaces. Positive and negative terminals situated on one edge on the cell case exterior are laterally-spaced from one another relative to the stacking axis and act as electrical contacts for connection (via busbar, for example) to an outside load or circuit. Within the cell case, numerous individual alternating positive and negative electrodes are spaced apart from one another along the stacking direction and kept electrically isolated by non-conductive separators. Leads from each of the negative electrodes are gathered together inside the cell case to feed the negative terminal, while leads from each of the positive electrodes are likewise gathered together to feed the positive terminal.

Traditional frames used to house battery cells are made from joined metal components. While capable of providing satisfactory support for the numerous cells, they tend to be heavy, while an assembly based on such frames involves a high part count, often requiring (in addition to the cells and the flex circuit) roughly 20 separate pieces. Moreover, they are prone to leakage due to the large gaps between mating components in the assembled module and additionally may provide a conductive path between the cells and ground, as well as between the positive and negative voltage terminals within each of the cells.

### SUMMARY OF THE INVENTION

The present invention solves the above problems by providing a rigid battery cell frame made from non-conductive plastic-based materials. In one aspect, an automotive battery pack assembly includes a plurality of prismatic battery cells arranged along a stacking axis, each of the cells defining laterally-spaced positive and negative cell terminals along an edge thereof. The assembly also includes a separate frame made up of foldable components that are made substantially from a polymeric material. The frame includes a top section disposed adjacent one edge of each of the cells, and numerous side sections cooperatively coupled to the top section to define an enclosure about the cells. The foldable sections of the frame are attached to a bottom section (which is preferably made from a polymeric material) disposed adjacent the terminal-bearing edge of each of the cells. In one form, apertures, protrusions and other features may be formed in or on the enclosure surface that faces or otherwise engages the cells, while in another form, built-in hinges permit selective latching between adjacent enclosure sections. While in a preferred configuration the bottom section is a separate, discrete piece that may be subsequently attached to the frame, in another form, it may also be integrally formed through the flexible hinges; both forms are deemed to be within the scope of the present invention. In the present context, the act of securing the various sections of the frame to one another, as well as securing the other attachable components (such as the bottom section) are sufficient to render the frame as an assembly. Other components made from other plastics, silicone or the like) may also be used; however, the predominant frame structure is made from polymeric materials with suitable structural (including fatigue) and electrical properties, such as polypropylene, polyphthalamide (PPA), nylon, polycarbonate/polybutylene terephthalate (PBT), thermoplastic olefin (TPO) or the like. With such construction, the proposed cage reduces gaps and leak paths where mating components are joined.

Within the present context, the assembly and the batteries contained therein form a modular structure that is compatible with automotive usage. Such modular structure may form a significant part of a battery pack that is considered to be a substantially complete assembly or system of components necessary for propulsion of the vehicle for which the pack was designed. Under such understanding, the battery modules and individual battery cells are (as mentioned above) considered to be subcomponents that are subsequently assembled into the pack or other larger part of the overall system Likewise, an assembly of components for a battery pack used for vehicular applications may include—in addition to numerous battery cells—cooling plates, securing mechanisms and other equipment that, while not contributing to the production of electric power or formation of the assembled cells and frame, make up an important part of the overall battery system packaging and assembly.

According to another aspect of the invention, an automotive battery pack assembly includes numerous prismatic can battery cells arranged along a stacking axis, each of the cells defining laterally-spaced positive and negative cell terminals along an edge thereof. A frame made substantially from a polymeric material includes a top section and various side sections. The top section forms a base to receive a corresponding edge of each of the cells that includes the projecting terminals, while the side sections are unitarily hinged to the top section such that prior to being folded into the shape of a cell-supporting enclosure, the shape of the top and side sections resemble an as-yet unfolded cardboard box. A bottom section may be secured to one or more of the side sections such that upon complete formation of the enclosure around the cells, the bottom is disposed adjacent the edge of the stacked cells that is opposite of the edge with the terminals. Such a bottom section may be either a separate section attachable to the unitary frame, or form part of the frame itself through a unitarily hinged connection. In the present context, a unitarily hinged connection or coupling is one where the hinge and the sections to which it is attached are formed of a one-piece construction (such as through molding of the same material); a more particular form of such hinge that is discussed within the present context is a living hinge, where the hinge is often necked or otherwise thinned relative to the more rigid sections to which it is attached.

According to yet another aspect of the invention, a method of a placing prismatic battery cells into a module includes providing a unitary frame made substantially from a polymeric material to define at least a top section and numerous side sections hingedly coupled to the top section. The cells are placed in a facingly adjacent (i.e., stacked) orientation with one another on the top section such that an edge defined along each of the cells is seated on a corresponding surface of the top section. The construction of the frame is such that its hinges allow folding of the side sections around the stacked cells such that an open box-like enclosure is formed except for the bottom of the cell stack that is opposite the edges with the protruding electrical terminals. Once such hinging has been performed to substantially enclose the top and side edges of the stacked batteries, a bottom section of the frame is placed such that an enclosure is formed substantially around the facingly adjacent cells.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 shows a vehicle with a hybrid propulsion system in the form of a battery pack and an internal combustion engine;

FIG. 2A shows an exploded view of various individual battery cells placed within a frame to define a battery pack or module assembly according to an aspect of the present invention;

FIG. 2B shows partial internal details of one of the prismatic can battery cells of the assembly of FIG. 2A;

FIGS. 3A through 3G show a sequence used to produce the assembly of FIG. 2A;

FIG. 4 shows a top view of the rigid polymeric frame of FIGS. 3A and 3B in its generally planar pre-assembled state to show the location of numerous living hinges;

FIG. 5 shows a section view taken from FIG. 3G that highlights a snap-fit feature between the terminals of the battery cells and a complementary apertures formed into the rigid polymeric frame; and

FIG. 6 shows a perspective view of a rigid polymeric frame according to another embodiment of the present invention with a different snap-fit closure for the sides of the frame.

### DETAILED DESCRIPTION OF THE PREFERRED EMBODIMENTS

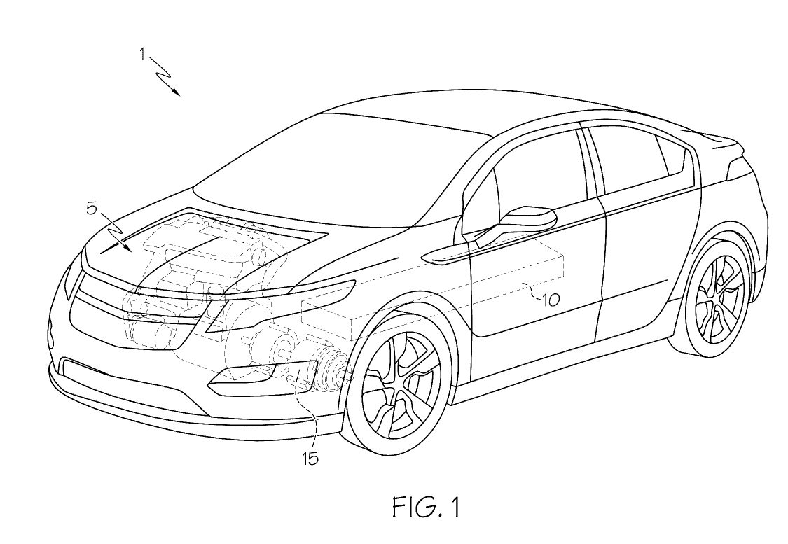

Referring first to FIG. 1, a vehicle 1 includes a hybrid propulsion system in the form of an electric power source made up of a conventional ICE 5 and a battery pack 10, both cooperative with an electric motor 15. Such a vehicle is known as a hybrid electric vehicle (HEV). It will be appreciated by those skilled in the art that vehicle 1 may not require an ICE 5, in such case, rather than being an HEV, it is an electric vehicle (EV); either form is within the scope of the present invention. Additional drivetrain components (none of which are shown) useful in providing propulsive power to one or more of the wheels and coupled to one or both of the battery pack 10 and ICE 5 are understood to include rotating shafts, axles, transmission, controllers or the like. While vehicle 1 is presently shown as a car, the applicability of the hybrid propulsion system to other such automotive forms (including trucks, buses, aircraft, watercraft, spacecraft and motorcycles) is deemed to be within the scope of the present invention.

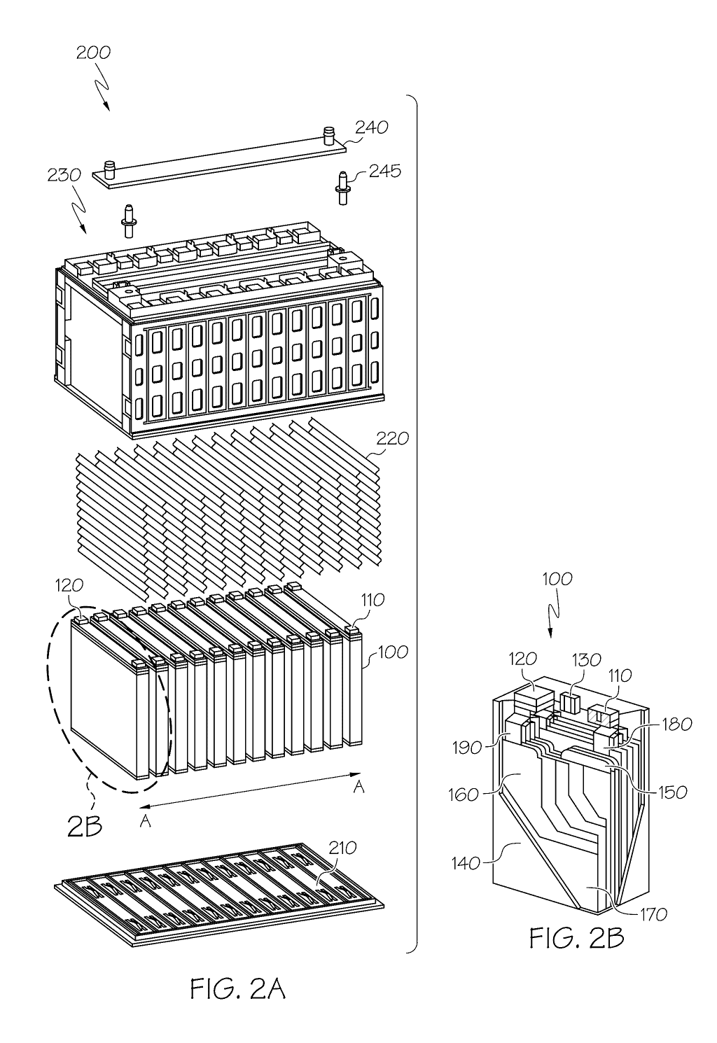

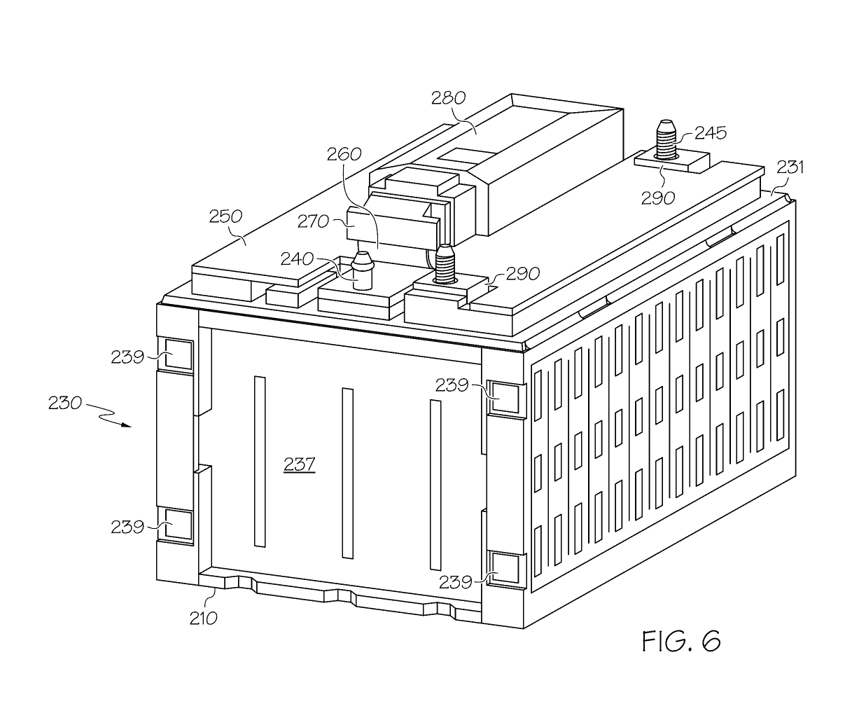

Referring next to FIGS. 2A and 2B, an exploded view of an assembly 200 made from a stacked arrangement of numerous prismatic lithium-ion battery cells (also referred to herein as prismatic can cell, prismatic cell, or more simply cell) 100 is shown, as well as a notional structure of each cell 100, for placement within the battery pack 10 of FIG. 1. As shown with particularity in FIG. 2A, the assembly 200—which is made from as few as four parts (in addition to the cells 100 and flex circuit (a portion of which is shown in FIG. 6 as 260) that may include bus cables, bus bars and their associated connectors)—includes a lower plate or tray 210, an optional set of cooling fins 220, a rigid frame 230 and a vent cap 240 arranged together such that a cage-like housing is formed around the stack of cells 100 and the cooling fins 220. Significantly, the lower plate 210, the frame 230 and the vent cap 240 are made from a polymeric material such as those mentioned above. The vent cap 240 in particular is used to provide a means to contain and properly route gases in the event of venting from one or more of cells 100. Threaded studs (or related terminals) 245 provide clamping interface for a main power connection; as such, they act as collars to facilitate the secure, accurate placement of electrode studs or terminals (not shown) to external electrical circuitry, such as the aforementioned flex circuit.

Referring with particularity to FIG. 2B, unlike pouch-style battery cell variants (not shown), which—although they have in common a generally flat, rectangular stackable shape in a manner generally similar to a prismatic cell—include numerous cells interspersed with cooling plates and other components, as well as thin peripheral edge and even thinner conductive foil tabs extending from the pouch edge, the prismatic cell 100 has the anode and cathode packaged within a welded rigid metal (for example, aluminum) rectangular canister, enclosure or similar self-supporting housing. While the cell 100 promotes scale-up and related design flexibility, increased care must be taken to promote more thorough sealing and thermal management approaches. Shown in a partial cutaway view, the notional construction of cell 100 that is usable with the present invention includes positive and negative terminals 110, 120 projecting out of its top edge, along with a safety vent 130; this safety vent 130 may be used in conjunction with the vent cap 240 to provide a secure venting path in the event of a need for one or more of the cells 100 to vent. Within the cell's 100 rigid outer case 140 are numerous positive and negative electrodes 150, 160 and non-conductive interspersed separators 170. Leads (in the form of tabs 180, 190) from each of the electrodes 150, 160 are gathered together inside the cell case 140 to feed the respective terminals 110, 120. As mentioned above, the cells 100 define a rigid, rectangular (i.e., prismatic) shape such that they are easily stacked in a facingly-adjacent relationship along a stacking axis A-A. The flex circuits (not shown) may be placed on top of the assembly 200 to form an electric circuit between the terminals 110, 120 of the stacked batteries 100 and a suitable load (such as electric motor 15 for propulsion, as well as other systems used to provide functionality to vehicle 10).

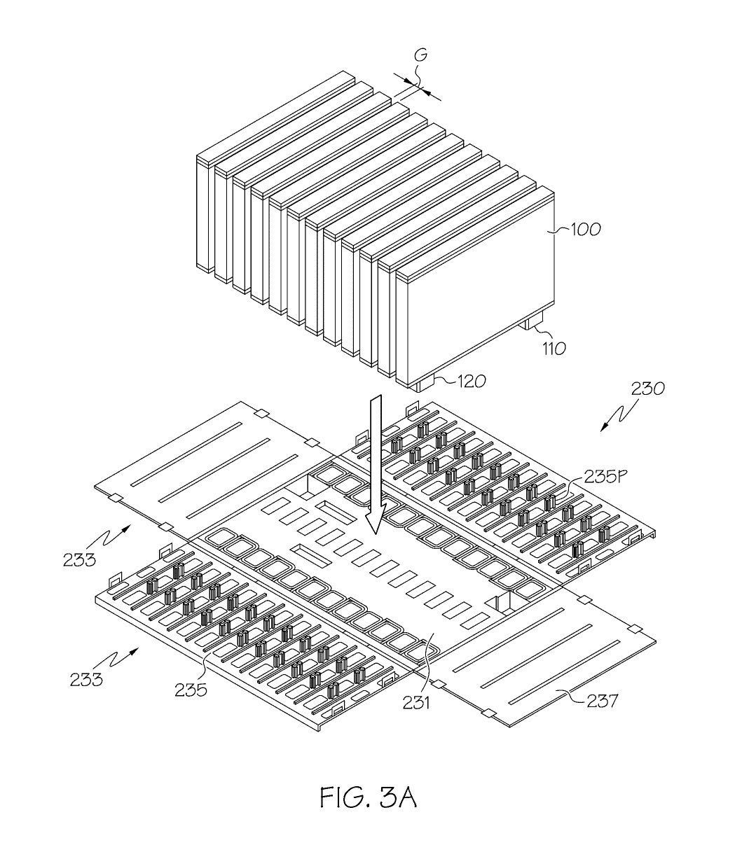

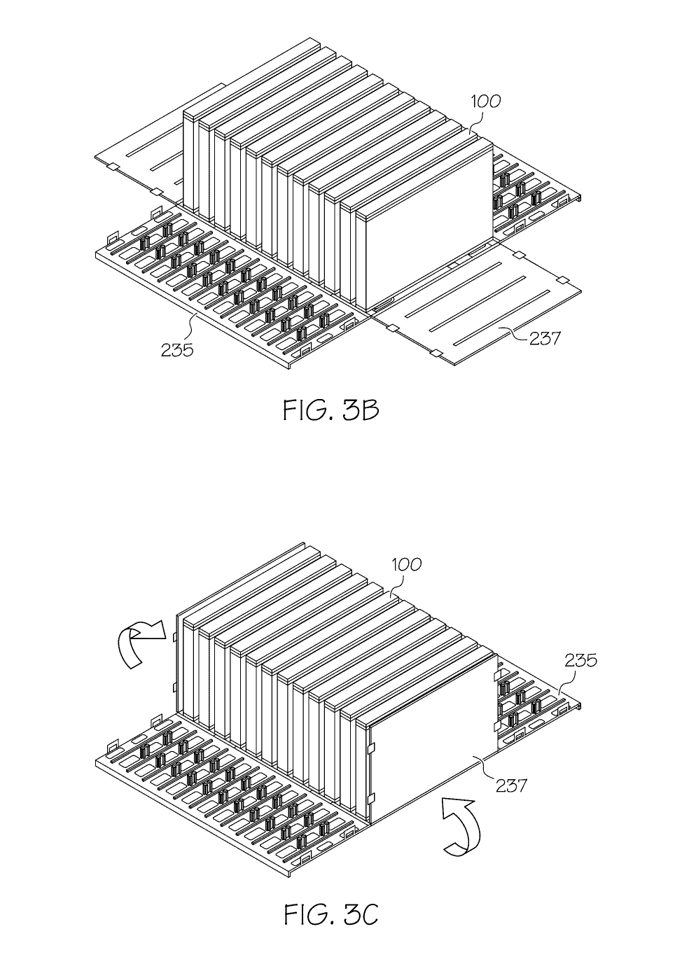

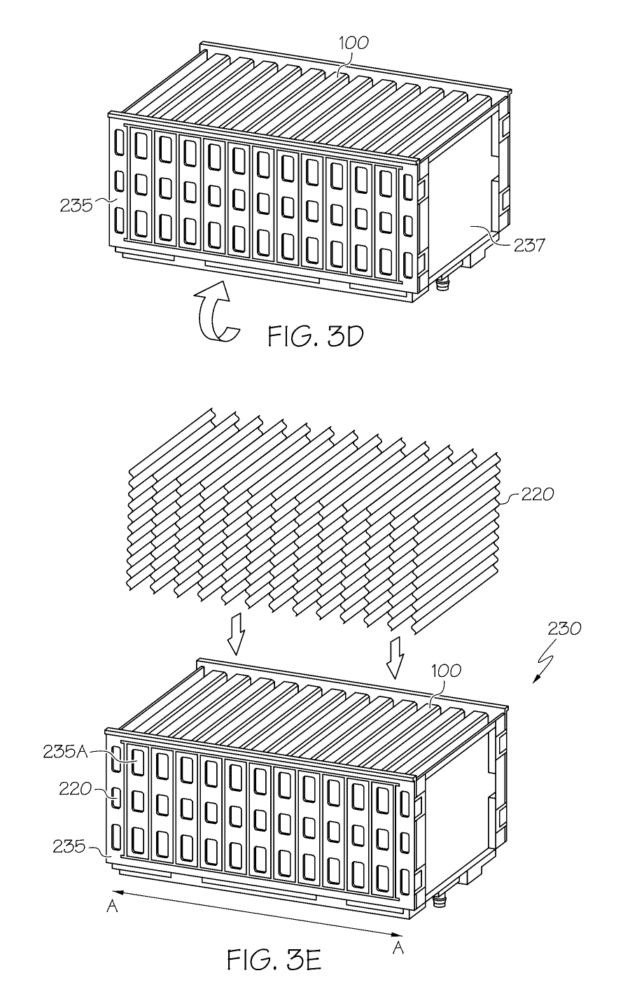

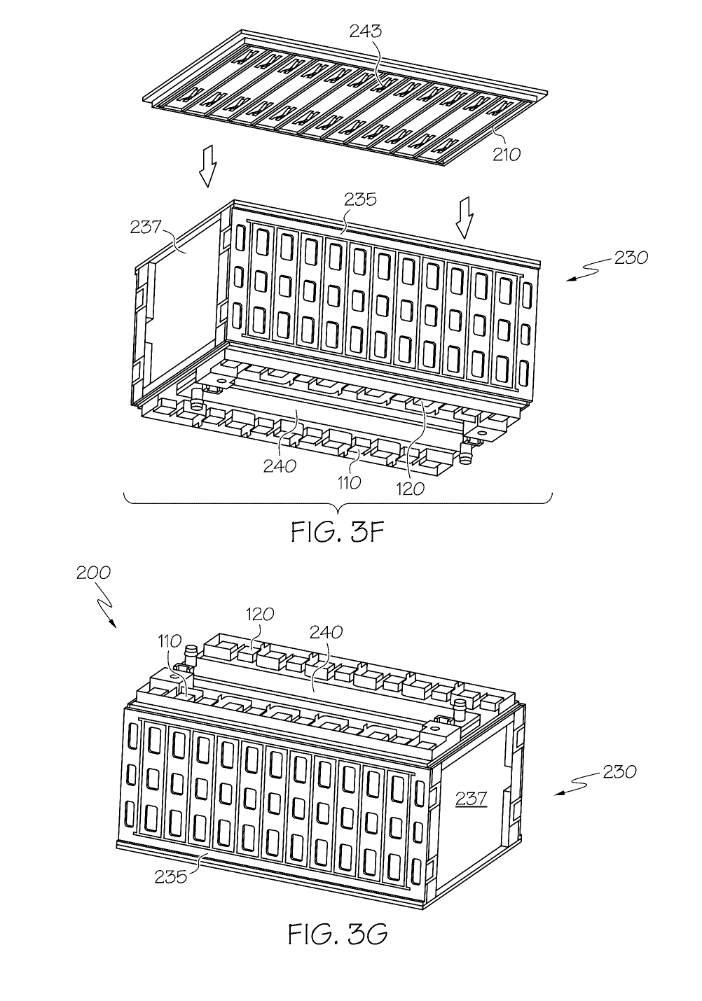

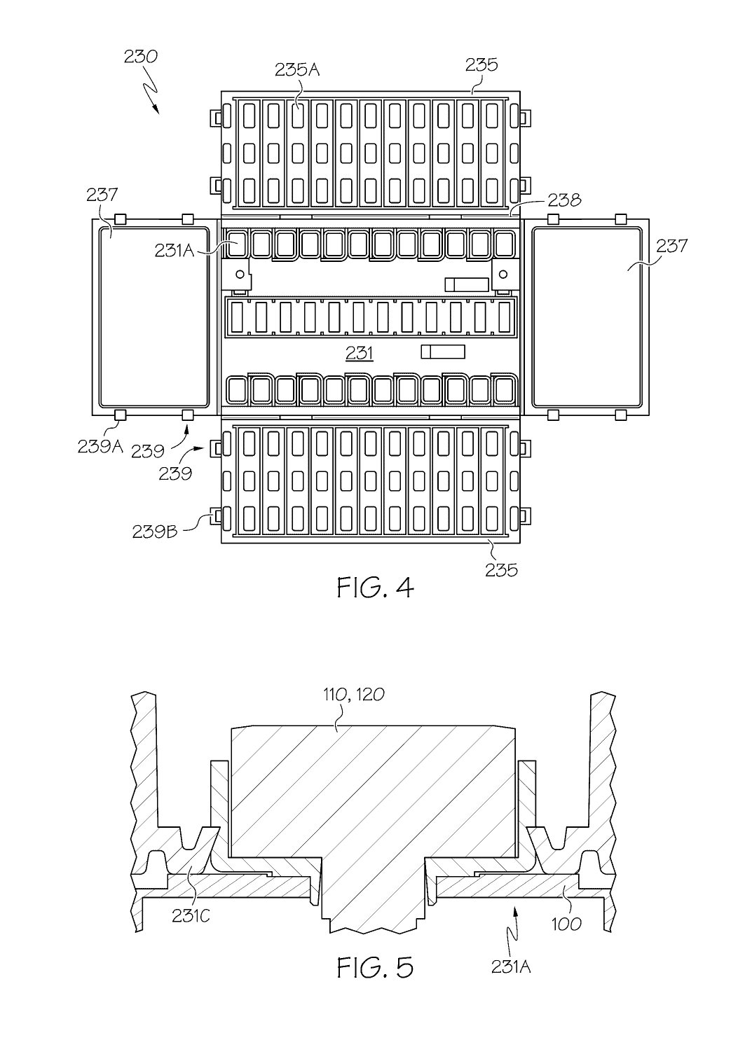

Referring next to FIGS. 3A through 3G in conjunction with FIG. 4, steps associated with forming the assembly 200 are shown. In general, the cells 100 are stacked in a face-to-face relationship such that their edges substantially align to define a generally rectangular shape. In the present context, the face-to-face relationship may also include configurations where there is a slight gap G between adjacent cells 100 to permit the placement of the optional cooling fins 220; the corrugated (or other undulated) shape of such fins 220 helps to define a cooling path.

Referring with particularity to FIG. 3A, rigid frame 230 is initially presented as a generally planar sheet that resembles a corrugated cardboard box prior to folding and gluing where, instead of cardboard, the frame 230 is made up of a single piece of the polymeric material discussed above. As will be discussed in more detail below in conjunction with FIG. 4, the frame 230 can be elastically deformed in select locations such as hinges to form a box-like housing structure for the stacked cells 100. The rigid frame 230 defines a top section 231 and hingedly-connected side sections 233 the latter of which in turn include both lateral portions 235 and end portions 237. The placement of the stack of cells 100 is such that the terminals 110, 120 are oriented downward along a substantially vertical axis.

As shown with particularity in FIG. 4, the frame 230 defines an inverted construction that differs from conventional box-like enclosures in that the placement of the stack of cells 100 starts along the top section 231 rather than the bottom section 210. Moreover, frame 230 includes numerous living hinges 238 that act as generally flat flexible springs to permit pivoting movement between the central top section 231 and the lateral portions 235 and end portions 237 of side section 233. Likewise, numerous fasteners in the form of latches 239 include a cooperative snap-fit between tabs 239A and apertures 239B each of which are formed on or in a respective part of the lateral portions 235 and end portions 237. The resiliently-biased nature of the latches 239 that are integrally formed along the edge of the end portions 237 is such that the protruding distal end of the tabs 239A may be temporarily compressed until it is moved into contact engagement with a corresponding aperture 239B near the edge of the adjacent lateral portion 235. As with the region that joins the top section 231 to the side section 233, the region where the tabs and apertures are formed may also include living hinges 238 to facilitate the snap-fit connection. The combined effect of the latches 239 and hinges 238 have the effect of permitting semi-permanent assembly of the top section 231 and the various flaps defined by the side sections 233 into a unitary—and substantially rectangular-shaped—box-like cage or housing such as shown in FIGS. 1 and 3D through 3G. Moreover, the construction of the assembly 200 of the present invention is better at controlling leakage than that of a conventional metal frame, as it seals around the cell terminals 110, 120 with no gaps between the top section 231 and the lateral portions 235. Moreover, the cooperation between the end portions 237 have fewer leak paths, making the frame 230 easier to be sealed. An array of generally rectangular-shaped apertures 231A are formed within the planar surface of the top section 231 to permit—among other things, access to the tops of the various battery cells 100. Additional details of these apertures 231A will be discussed in more detail in conjunction with FIG. 5. Similar apertures 235A may be formed in the surface of one or both of the lateral portions 235, and their function will be discussed in more detail below in conjunction with FIG. 3D.

As shown with particularity in FIGS. 3B through 3D in conjunction with FIG. 4, the aligned stack of cells 100 are first placed onto the top section 231 such the top edges (which contains the positive and negative terminals 110, 120) of each cell 100 rest upon the surface of the top section 231. At least a portion of the array of apertures 231A are sized and shaped to accept the corresponding-shaped terminals 110, 120 such that the latter are seated in the former. Periodically-spaced projections 235P formed in the lateral portion 235 of side section 233 may help define channels or related seating along the height wise dimension of the formed frame 230; in addition to promoting a secure, repeated placement of the stacked cells 100 into the cage-like housing formed by the frame 230, these projections 235P help establish the axial gap G identified in FIG. 3A between adjacent cells 100, as well as help establish seating or related registration (i.e., cell positioning or locating) between each of the cells 100 and their corresponding place within the frame 230. Notwithstanding the fact that the cells 100 include projections in the form of terminals 110, 120 along their top edge, and that the cell-engaging surfaces of the frame 230 may include various seats, channels and projections as a way to better secure the cells 100, both the frame 230 and the cells 100 define substantially rigid rectangular shapes with substantially planar complementary surfaces, as readily apparent from FIGS. 3A through 3D.

As assembled per FIG. 3D, five of the six sides of the box-like structure to provide containment and support for the numerous individual battery cells 100 are in place. At this juncture, and referring with particularity to FIG. 3E, the stacked prismatic can battery cells 100 that are spaced an amount sufficient along the stacking axis A-A with axial gaps G may receive corrugated cooling fins 220. As mentioned above, in the event that fins 220 or other cooling structure is required, the projections 235P that can be seen in FIGS. 3A through 3D help keep the spacing between adjacent cells 100 consistent and repeatable. Moreover, the apertures 235A that are formed in the lateral portion 235 of side section 233 are generally aligned with the fins 220 so that heat may be directed outward (under either passive or forced convection) from the stacked cells 100 and frame 230 along flowpaths defined by the apertures 235A and fins 220.

Referring next to FIGS. 3F, 3G and 5, the stacked cells 100 and frame 230 are then turned upside down so that the lower plate 210 can be attached from the top. Lower plate 210 may also include spring biased projections 243 formed on its surface to help provide a tight fit against the bottom edge of the various cells 100. In one preferred configuration, the projections 243 are integrally-formed within the lower plate 210 to define a unitary structure; in one manner, they together may be made from a suitably-configured mold. Thus, the weight of the cells 100 is sufficient to slightly compress the projections 243 in order to promote a secure, substantially rattle-free placement of the cells 100 within frame 230. Moreover, because the size and shape of both the cell 100 and the corresponding inner surfaces of the frame 230 is such that both define a generally rectangular profile so that the generally planar complementary contact surfaces between the outer lateral edges of the cell 100 and the adjacent inner sidewalls defined by the frame 230 further promote contact engagement to ensure a snug, secure fit of the former into the latter. Once the lower plate 210 is secured to the frame 230, the assembly defines all six sides of the box-like structure to provide containment and support for the numerous individual battery cells 100. In a preferred embodiment, the lower plate 210 is designed to be ultrasonically welded to the top frame, thereby further helping to keep leakage low in a manner similar to the continuously-formed hinges between the lateral portion 235 of side section 233 and top section 231, as well as between the end portions 237 of side section 233 and the top section 231. At this time, the assembly 200 may be returned to its proper orientation as shown with particularity in FIG. 3G so that the terminals 110, 120 of each of the cells 100 are upward-facing.

Referring with particularity to FIG. 5, the apertures 231A that are formed in the surface of the top section 231 may further define resiliently-biased connectors 231C that by pressing against the sides of cell terminals 110, 120 can help to maintain the snug fit of the cells 100 in the box-like enclosure formed by frame 230. The resilient bias of the connectors 231C may also be made to resemble the snap-fit features of the latches 239 discussed above; either form of biasing of the connectors 231C is deemed to be within the scope of the present invention. As mentioned above, with the containment construction enabled by the assembly 200 of the present invention, gaps and leak paths where mating components are joined are significantly reduced or eliminated. This is especially true in the areas adjacent the battery terminals 110, 120, where the assembly 200 provides a sealed joint on its top section.

Referring next to FIG. 6, variations on the snap-fit features of the latches 239 used to secure the sides of the frame of FIGS. 3A through 3G and 4—as well as a few additional components associated with assembly 200—are shown. In essence, the snap-fit features form a different hinge arrangement in that rather than having the tabs 239A inserted into apertures 239B, a surface-mounted buckle arrangement is used. In this way, there are fewer leakage pathways formed near the seam where the lateral portions 235 and end portions 237 are joined. Additional assembly 200 components, such as the module cover 250 (which may also be made from a polymeric material) may be placed on top of the top section 231. Such a cover provides additional environmental protection for the battery, as well as a mounting surface for a flex circuit connector 260 to receive a corresponding end of flex circuit 270, as well as a cell balancing board 280. Likewise, other electrical features (such as ring terminals 290 that extend from the flex circuit 260) are disposed around the threaded studs 245 that protrude from the top of the assembly 200.

It is noted that terms like “preferably”, “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Likewise, terms such as “substantially” are utilized to represent the inherent degree of uncertainty that may be attributed to any quantitative comparison, value, measurement, or other representation. It is also utilized to represent the degree by which a quantitative representation may vary from a stated reference without resulting in a change in the basic function of the subject matter at issue.

For the purposes of describing and defining the present invention it is noted that the term “device” is utilized herein to represent a combination of components and individual components, regardless of whether the components are combined with other components. For example, a device according to the present invention may comprise a battery or related source of electric power that in turn may be used to provide motive power. A device may also refer to a vehicle incorporating the source of motive power or other equipment that may make up, or be used in conjunction with, the vehicle or source of motive power; the nature of the device will be clear from the context. Furthermore, variations on the terms “automobile”, “automotive”, “vehicular” or the like are meant to be construed generically unless the context dictates otherwise. As such, reference to an automobile will be understood to cover cars, trucks, buses, motorcycles and other similar modes of transportation unless more particularly recited in context Likewise, the invention may be used in conjunction with battery cells unrelated to automotive applications, where temperature-sensitive equipment may need added thermal protection; such additional configurations are understood as being within the scope of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An automotive battery pack assembly comprising:
a plurality of prismatic battery cells arranged along a stacking axis, each of said cells defining laterally-spaced positive and negative cell terminals along an edge thereof; and
a frame assembly comprising a plurality of components each made substantially from a polymeric material, said components comprising:
a top section disposed adjacent said edge of each of said cells that has said terminals, said top section defining a plurality of apertures therein to accept said terminals therein;
a bottom section disposed adjacent an edge of each of said cells that is substantially opposite of said terminals; and
a plurality of side sections cooperatively coupled to said top and bottom sections to define an enclosure about said cells.

2. The assembly of claim 1, wherein each of said frame and said cells define substantially rigid rectangular shapes with substantially planar complementary surfaces.

3. The assembly of claim 1, further comprising a plurality of cooling fins each facingly interspersed between an adjacent pair of said cells.

4. The assembly of claim 1, wherein at least one of said side and top sections define apertures therein.

5. The assembly of claim 4, wherein said apertures defined in said top section further define a biased connector operative to secure said terminals to said top section.

6. The assembly of claim 1, further comprising hinges to define said cooperative coupling between at least one of (a) adjacent ones of said side sections and (b) said side sections and at least one of said top and bottom sections.

7. The assembly of claim 6, wherein said hinges define living hinges.

8. The assembly of claim 6, wherein said hinges used to secure said side sections to one another comprises a snap-fit connection.

9. The assembly of claim 1, wherein at least one of said bottom, side and top sections define a cell seating area therein through at least one of apertures, channels and projections.

10. The assembly of claim 1, further comprising a vent cap situated on said top section and defining a path therein that is in fluid communication with said plurality of cells to provide selective venting therefor.

11. The assembly of claim 1, wherein a location within said frame assembly defines a continuous connection between said plurality of side sections and said top section such that no fluid leakage path is defined thereby.

12. An automotive battery pack assembly comprising:
a plurality of prismatic can battery cells arranged along a stacking axis, each of said cells defining laterally-spaced positive and negative cell terminals along an edge thereof; and
a unitary frame made substantially from a polymeric material, said frame comprising:
a top section disposed adjacent said edge of each of said cells that has said terminals; and
a plurality of side sections hingedly coupled to said top section; and
a bottom section configured to receive an edge of each of said cells that is substantially opposite of said terminals, said bottom section cooperative with said frame such that upon connection therebetween they define an enclosure about said cells.

13. The assembly of claim 12, wherein said bottom section comprises a polymeric material.

14. The assembly of claim 13, further comprising a plurality of cooling fins each facingly interspersed between an adjacent pair of said cells.

15. A method of assembling a plurality of prismatic battery cells into a module, said method comprising:
providing a unitary frame made substantially from a polymeric material, said frame comprising at least a top section and a plurality of side sections hingedly coupled to said top section;
placing a plurality of said cells in facingly adjacent orientation with one another on said top section such that an edge defined along each of said facingly adjacent cells is seated on a corresponding surface thereof;
hingedly folding said plurality of side sections around said facingly adjacent cells; and
placing a bottom section onto said hingedly folded side sections such that an enclosure is formed around said facingly adjacent cells.

16. The method of claim 15, wherein said placing a plurality of said cells in facingly adjacent orientation with one another on said top section takes place in a substantially top-down direction along a substantially vertical axis.

17. The method of claim 16, further comprising vertically inverting said facingly adjacent cells and said folded side sections and top section prior to said placing a bottom section onto said hingedly folded side sections.

18. The method of claim 15, further comprising disposing a plurality of cooling fins each in between a respective pair of said facingly adjacent cells prior to said placing a bottom section onto said hingedly folded side sections.

19. The method of claim 18, wherein at least one of said side and top sections defines a plurality of apertures therein, and wherein at least said apertures defined in said top section further define a biased connector operative to secure said terminals to said top section.
